(19) United States
(12) Patent Application Publication
(10) Pub. No.: US 2006/0181791 A1
(43) Pub. Date: Aug. 17, 2006

(54) Method and apparatus for determining a property of a fluid which flows through a biological tubular structure with variable numerical aperture

(76) Inventors: Michael Cornelis Van Beek, Eindhoven (NL); Jan Baptist Adrianus Maria Horsten, Eindhoven (NL); Marjolein Van Der Voort, Eindhoven (NL); Gerhardus Wilhelmus Lucassen, Eindhoven (NL); Peter Jacobus Caspers, Rotterdam (NL)

Correspondence Address: PHILIPS INTELLECTUAL PROPERTY & STANDARDS, 595 MINER ROAD, CLEVELAND, OH, 44143, US

(21) Appl. No.: 10/566,346

(22) PCT Filed: Jul. 26, 2004
(86) PCT No.: PCT/IB04/51291

§ 371 Date: Jan. 27, 2006

(30) Foreign Application Priority Data
Jul. 31, 2003 (EP) 031023807

(51) Int. Cl. G02B 5/08; G02B 7/195

(52) U.S. Cl. 359/845

(57) ABSTRACT

The present invention provides for an apparatus and a method for determining a property of a fluid which flows through a biological tubular structure, such as blood flowing through a capillary vessel (112) under the skin (114). This enables in vivo non-invasive blood analysis. An objective (108) having a variable numerical aperture (116) is used to enable automatic detection of a blood vessel (112) and to provide a high signal to noise ratio of the return radiation for the purposes of the spectroscopic analysis and to provide a small detection volume that fits completely within the target region.

### FIELD OF THE INVENTION

The present invention relates to the field of optical spectroscopy, and more particularly to the usage of optical spectroscopic techniques for analytical purposes.

### BACKGROUND AND PRIOR ART

Usage of optical spectroscopic techniques for analytical purposes is as such known from the prior art. WO 02/057759 A1 shows a spectroscopic analysis apparatus for in vivo non-invasive spectroscopic analysis of the composition of blood flowing through a capillary vessel of a patient. The capillary vessel is imaged by a monitoring system and an excitation beam is directed to the capillary vessel in order to perform the spectroscopic analysis. For example near-infrared radiation is used for excitation of Raman scattering. The Raman scattered radiation is spectroscopically analysed for determination of blood properties.

The in vivo analysis of blood has a number of advantages as compared to prior art blood analysis, where blood is drawn from the arm, for example with the use of a needle, and the blood sample is analysed in a chemical laboratory. The transport and the analysis take a considerable amount of time, varying between two days and typically 20 minutes in emergency situations. In contrast, in vivo blood analysis enables to instantaneously and continuously monitor the properties of blood without pain and risk of infections for the patient.

The present invention therefore aims to provide an improved method of non-invasive determination of a property of a fluid which flows through a biological tubular structure, in particular for in vivo non-invasive analysis of blood flowing through the capillary vessels in the skin of a patient

### SUMMARY OF THE INVENTION

The present invention provides for an apparatus, a computer program product and a method of determining a property of a fluid which flows through a biological tubular structure which enables the optical detection of the biological tubular structure as well as the spectroscopic analysis by varying the numerical aperture.

The optical detection of the position of the biological tubular structure is performed using a low numerical aperture. A low numerical aperture implies a large depth of field (DOF) which is also referred to as ‘range of focus’. This enables to detect biological tubular structures at various depths within the DOF. For example, on the wrist the capillary vessels of a human are typically located about 60 to 120 micrometres under the skin surface. The low numerical aperture is required for the optical detection step in order to enable detection of capillary vessels within that depth range under the skin surface. The position of the biological tubular structure which has been determined by means of the optical detection at the same time defines a detection volume within the biological tubular structure for the optical spectroscopic analysis. For the optical spectroscopy a high numerical aperture is used in order to collect as much scattered radiation from the detection volume as possible in order to increase the signal to noise ratio. A high numerical aperture (NA) is also required to provide a small detection volume. This is needed to collect a spectroscopic signal from blood without contributions of skin. A typical blood capillary has a diameter of 10 micrometer. For example, a NA of 0.7 or higher enables to provide a detection volume that is smaller than 10 micron in all three dimensions.

The present invention is particularly advantageous in that it enables to optically detect a biological tubular structure within a certain depth range under the skin surface and to perform an optical spectroscopic measurement with a high signal to noise ratio and to provide a small detection volume that fits completely within the target region. The optical detection and the spectroscopic measurement can be simultaneous or can be consecutive.

In accordance with a preferred embodiment of the invention an objective with a variable numerical aperture is used. The same objective can be used both for the optical detection of the biological tubular structure and for the optical spectroscopy. The variable numerical aperture of the objective can be realized by means of a variable diaphragm, which provides the lower numerical aperture for the optical detection of the biological tubular structure and the high numerical aperture for the optical spectroscopy. First a low numerical aperture is used for optical detection of a tubular structure within a large depth range under the skin surface. Next a high numerical aperture is used for an optical spectroscopic measurement. During the spectroscopic measurement, the high numerical aperture can be used to track the position of the tubular structure optically with high accuracy.

In accordance with a further preferred embodiment of the invention the diaphragm is located outside the objective near one of the pupils or further away from the objective in the light path to the imaging and Raman systems.

A further embodiment is to have different variable NA's for the imaging and spectroscopic systems. This can be done by a variable diaphragm in the imaging light path (e.g. between beam splitter and CCD detector) and perhaps a second variable diaphragm in the spectroscopic light path (e.g. between the beam splitter and the Raman system). This has the advantage that the NA used for imaging and spectroscopy can be adjusted independently. Further it is possible to position the imaging diaphragm in the illumination and detection path or only in the detection path, such as between polarizing beam splitter and the CCD camera. For OPS imaging the NA is not important for illumination and this has the advantage that as much light as possible is used for illumination, whereas the depth of field can be adjusted by the diaphragm. In the same way it is possible to position a spectroscopic diaphragm in the combined Raman excitation and detection pathway, or in one of two pathways. Preferably the maximum NA is always used for the Raman light path and only one diaphragm in the imaging path is required.

In accordance with a further preferred embodiment one or two exchangeable diaphragms rather than variable diaphragms are used.

In accordance with a further preferred embodiment of the invention an imaging method is employed for determination of the position of the biological tubular structure, such as a pattern recognition technique. Alternatively confocal laser scanning microscopy (CLSM), orthogonal polarised spectral imaging (OPSI), optical coherence tomography (OCT) or photoacoustic imaging is used for the detection of the biological tubular structure.

In accordance with a further preferred embodiment of the invention confocal Raman spectroscopy is used. Light from a Raman excitation laser is directed towards the detection volume through the objective and Raman scattered radiation is collected by the same objective for spectroscopic analysis. It is to be noted that the present invention is not restricted to spontaneous Raman spectroscopy but that other optical spectroscopic techniques can also be used. This includes (i) other methods based on Raman scattering including stimulated Raman spectroscopy and coherent anti-stokes Raman spectroscopy (CARS), (ii) infra-red spectroscopy, in particular infra-red absorption spectroscopy, Fourier transform infra-red (FTIR) spectroscopy and near infra-red (NIR) diffuse reflection spectroscopy, (iii) other scattering spectroscopy techniques, in particular fluorescence spectroscopy, multi-photon fluorescence spectroscopy and reflectance spectroscopy, and (iv) other spectroscopic techniques such as photo-acoustic spectroscopy, polarimetry and pump-probe spectroscopy. Preferred spectroscopic techniques for application to the present invention are Raman spectroscopy and fluorescence spectroscopy.

In accordance with a further preferred embodiment of the invention the low numerical aperture for the optical detection of the biological tubular structure is below 0.3, preferably 0.1. This provides a large range of focus for the detection of the biological tubular structure at various depths below the surface of the body.

In accordance with a further preferred embodiment of the invention the high numerical aperture for the optical spectroscopy is above 0.6, preferably above 0.8. This way a large proportion of the return radiation from the detection volume is collected which increases the signal to noise ratio. A second advantage of a high numerical aperture is a small detection volume that fits completely in a blood vessel.

In accordance with a further preferred embodiment of the invention a movement of the biological tubular structure during the analysis is tracked. This enables to move the detection volume together with a move of the biological tubular structure. This way measurement errors due to a movement of the patient can be avoided. In particular this eliminates errors which can be caused by breathing or other unintentional movements of the patient. The tracking of the movement of the biological tubular structure is performed by optical detection of the movement using a high numerical aperture for precise tracking of the movement. Especially the accuracy in the z-direction strongly depends on the size of the NA.

In accordance with a further preferred embodiment of the invention the two dimensional position of the biological tubular structure is determined using a low numerical aperture. After the two dimensional position has been determined a high numerical aperture is used for determining the position of the biological tubular structure in the third dimension, i.e. in a direction transversal to the surface of the body. This can be done by scanning through the range of focus of the low numerical aperture by acquiring a sequence of images with the high numerical aperture.

The present invention is particularly advantageous for performing in vivo non-invasive blood analysis. In this instance the confocal detection volume is located inside a blood capillary with a typical diameter of 10 micrometres. When the blood capillary is slightly moved this movement can be tracked and the detection volume can also be moved together with the blood capillary.

The invention also relates to a computer program to control the optical detection means. The computer program according to the invention is defined in claim 16. Preferably in the computer program product, the program means are adapted to control an objective having a variable numerical aperture to provide the first and the second numerical apertures. Preferably in the computer program product, the program means are adapted to control the optical detection means for tracking a movement of the biological tubular structure while controlling the objective to provide the second numerical aperture. Preferably in the computer program product, the program means are adapted to control the optical detection means to determine the depth of the biological tubular structure under a surface of the body while controlling the objective to provide the second numerical aperture. Preferably in the computer program product, the program means are adapted to control the optical detection means to perform a number of imaging steps for scanning along a direction being transversal to the surface of the body while controlling the objective to provide the second numerical aperture.

The invention also relates to an apparatus for determining a property of a fluid. The apparatus according to the invention is defined in claim 17. Preferably in the apparatus, the optical means has an objective with a variable numerical aperture. Preferably, the objective has a variable diaphragm. Preferably in the apparatus, the optical means has an exchangeable diaphragm for providing the first and the second numerical apertures.

### BRIEF DESCRIPTION OF THE DRAWINGS

In the following preferred embodiments of the invention will be described in greater detail by making reference to the drawings in which:

FIG. 1 is a block diagram of a first embodiment of an apparatus of the invention,

FIG. 2 is a block diagram of a second embodiment of an apparatus of the invention,

FIG. 3 is illustrative of a flow chart of an embodiment of the invention,

FIG. 4 is illustrative of the determination of the depth of a blood vessel.

### DETAILED DESCRIPTION

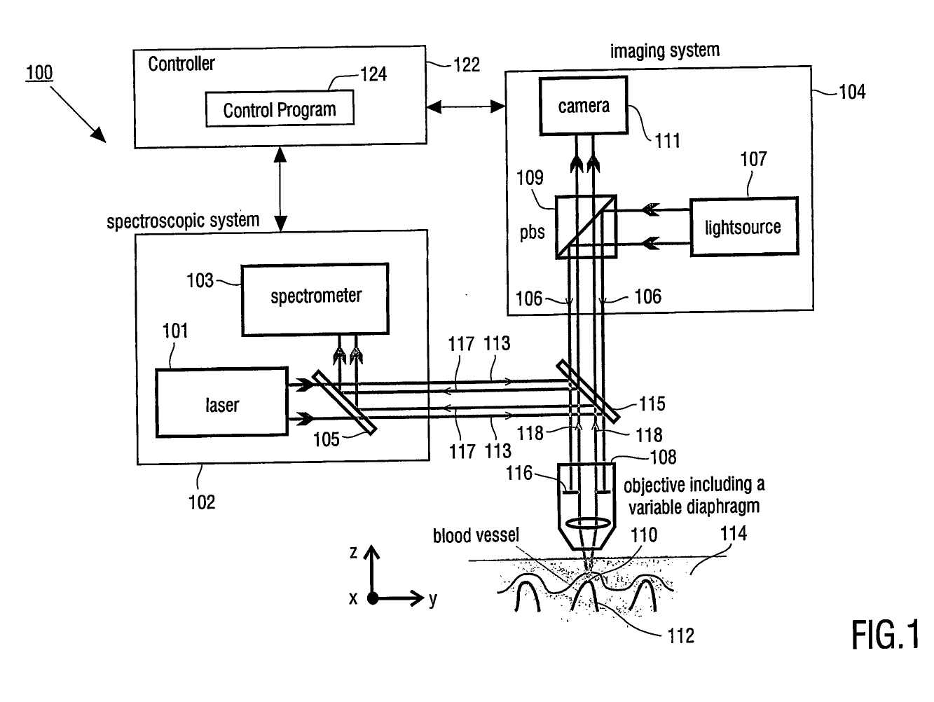

FIG. 1 shows a block diagram of an apparatus which can be used for determining a property of a fluid which flows through a biological tubular structure, such as blood flowing through a capillary vessel under the skin of a patient. Apparatus 100 has Raman spectroscopic system 102 for confocal Raman spectroscopy and imaging system 104.

Raman spectroscopic system 102 has laser light source 101 and spectrometer 103. Raman return radiation is directed to spectrometer 103 by mirror 105 of spectroscopic system 102.

Imaging system 104 has light source 107, which provides an incident light beam 106, which is directed through objective 108 to detection volume 110, which is located within blood vessel 112 in skin 114 of a patient's body. Objective 108 has variable diaphragm 116, which enables to control the numerical aperture of objective 108.

Further imaging system 104 has polarizing beam splitter 109 and CCD camera 111.

Incident light beam 106 of light source 107 causes return light 118 which is received by imaging system 104, i.e. CCD camera 111. Incident laser light beam 113 of laser light source 101, which is directed to detection volume 110 by mirror 115 through objective 108 causes Raman return light beam 117, which is reflected by mirrors 115 and 105 to spectrometer 103 for spectroscopic analysis. Laser light source 101 may operate at the same or a different wavelength as light source 107 of imaging system 104. Light, which is emitted by a laser light source 101 scatters elastically or in-elastically (Raman) and causes Raman return light beam 117.

The operation of Raman spectroscopic system 102 and imaging system 104 as well as of diaphragm 116 of objective 108 is performed by controller 122 which has control program 124.

In operation control program 124 issues a control signal to objective 108 such that diaphragm 116 is set to provide a low numerical aperture. Next imaging system 104 is invoked in order to detect the position of one of the blood vessels, i.e. blood vessel 112. This way the x and y-position of detection volume 110 within blood vessel 112 is also determined. Control program 124 issues a control signal to objective 108 to set diaphragm 116 to a high numerical aperture. Next an imaging step is performed to find the right depth of the detection volume under the skin surface, i.e. the z-position.

Subsequently Raman spectroscopic system 102 is invoked for performing a spectroscopic analysis of return light 117. This way one or more properties of the blood flowing through blood vessel 112 are determined. So, for example the low numerical aperture is used for initial x, positioning whereas a high numerical aperture is used for the initial z-positioning, tracking and spectroscopy.

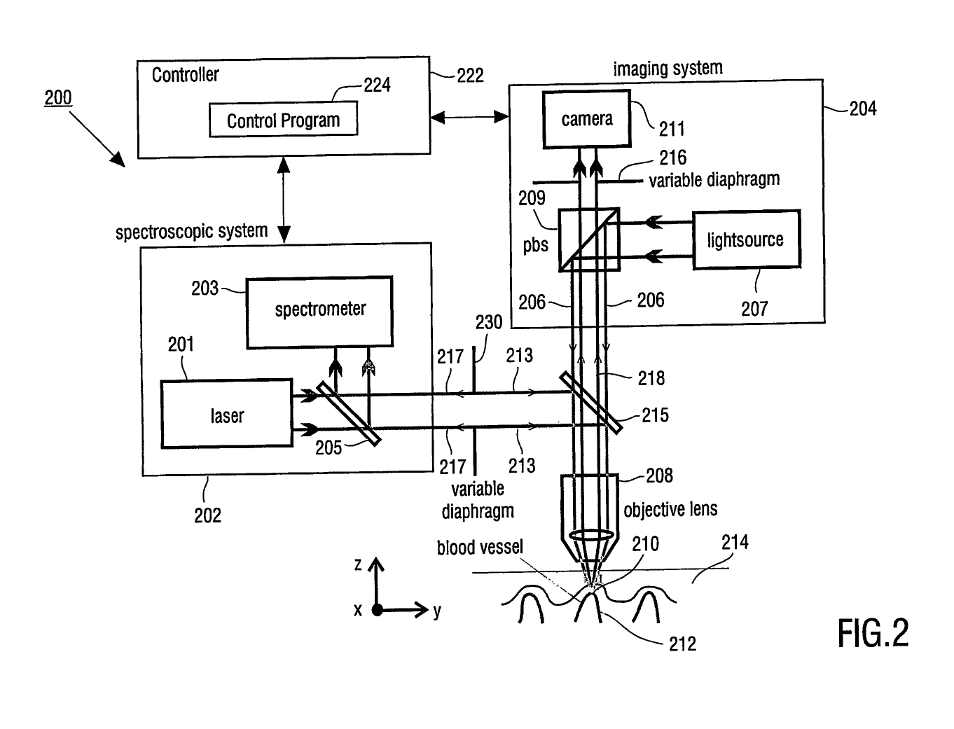

FIG. 2 shows a block diagram of an alternative embodiment. Elements of the embodiment of FIG. 2, which correspond to elements in the embodiment of FIG. 1 are designated with like reference numerals having added 100.

In contrast to the embodiment of FIG. 1 objective 208 of apparatus 200 of FIG. 2 does not have a variable diaphragm. Rather the variable diaphragm 216 is located between polarizing beam splitter 209 and camera 211. This way a low numerical aperture for identification of the position of blood vessel 212 by imaging system 204 is realized.

In addition there can be variable diaphragm 230 between mirror 205 and mirror 115 to set the numerical aperture for the spectroscopic system 202. Diaphragm 230 is however not essential as the maximum numerical aperture is a best for performing the Raman spectroscopy.

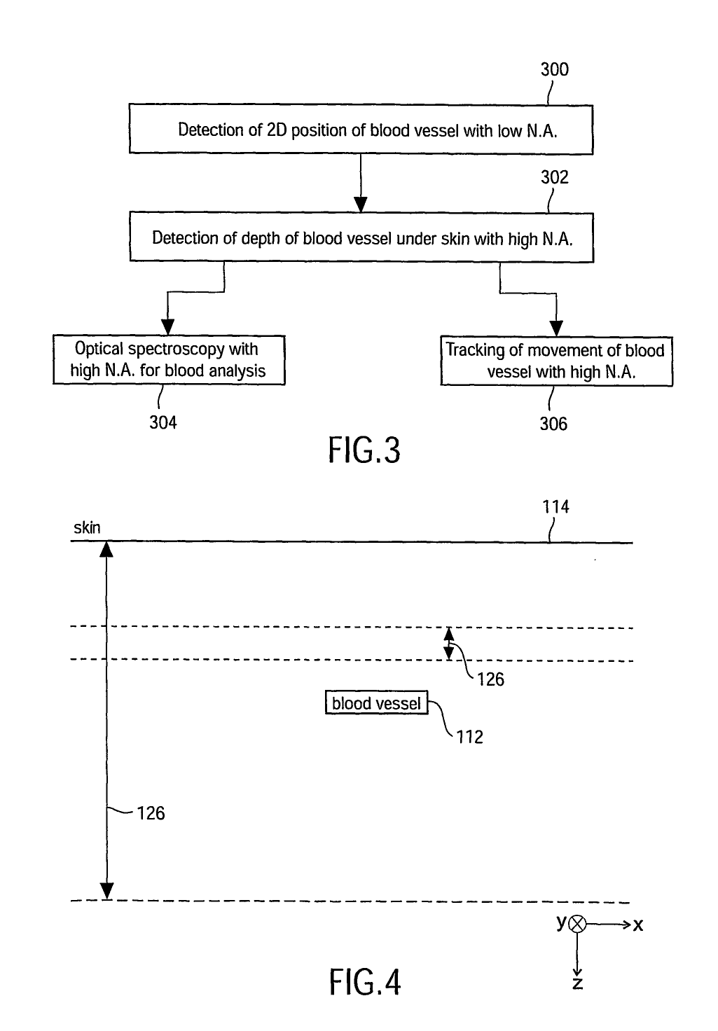

FIG. 3 shows a flow chart of a further preferred embodiment. In step 300 a two dimensional position of a blood vessel in the skin is detected with a low numerical aperture. In step 302 the transversal position of the blood vessel under the skin surface is detected with a high numerical aperture. This is done by scanning through the range of focus provided by the low numerical aperture in step 300, i.e. a sequence of images with a high numerical aperture is taken. Each of the images has another focus plane within the range of focus for detection of the blood vessel.

In step 304 the blood flowing through the detected blood vessel is analysed by means of optical spectroscopy using a high numerical aperture. Usage of a high numerical aperture ensures that the objective collects a large proportion of the return radiation and thus implies a high signal to noise ratio and a small detection volume that lies completely inside a blood vessel.

In parallel a movement of the blood vessel can be tracked in step 306. This is done by means of the imaging system using the same objective with the high numerical aperture used for the optical spectroscopy. This enables a precise tracking of the movement of the blood vessel in all three dimensions. This has the advantage that the detection volume for the optical spectroscopy can be moved together with the movement of the blood vessel such that measurement errors can be avoided.

The detection of the depth of the blood vessel under the skin which is performed in step 302 is schematically illustrated in FIG. 4. The two dimensional x, y position of blood vessel 212 is detected in step 300 by means of a low numerical aperture corresponding to depth of field 126. The z-coordinate of blood vessel 212 is detected in step 302 with a high numerical aperture corresponding to a narrow depth of field 128. The narrow depth of view is also referred to as “focus plane”.

The z-coordinate is determined by scanning depth of field 126 in the z-direction with the high numerical aperture imaging. This can be done by acquisition of a sequence of images having varying positions of the respective focus planes along depth of field 228. The position of the focus plane of the image in which the blood vessel 212 is found indicates the z-coordinate.

### LIST OF REFERENCE NUMERALS

100 apparatus
101 laser light source
102 Raman spectroscopic system
103 spectrometer
104 imaging system
105 dichroic mirror
106 incident imaging light beam
107 light source
108 objective
109 polarizing beam splitter
110 detection volume
111 CCD camera
112 blood vessel
113 incident laser light beam
114 skin
115 dichroic mirror
116 diaphragm
117 Raman return light beam
118 return light
122 controller
124 control program
126 depth of field for a system with a high NA
128 depth of field for a system with a low NA
200 apparatus
201 laser light source
202 Raman spectroscopic system
203 spectrometer
204 imaging system
205 dichroic mirror
206 incident light beam
207 light source
208 objective
209 polarizing beam splitter
210 detection volume
211 CCD camera
212 blood vessel
213 incident laser light beam
214 Skin
215 dichroic mirror
216 Diaphragm
217 Raman return light beam
218 return light
222 controller
224 control program
230 diaphragm

1. An apparatus for determining a property of a fluid which flows through a biological tubular structure, the apparatus operable for:
performing an optical detection step for determining a position of the biological tubular structure,
performing an optical spectroscopic step for determining of the property of the fluid in a detection volume, the location of the detection volume being determined by the position,
whereby a first numerical aperture is used for performing the optical detection step and a second numerical aperture is used for performing the optical spectroscopic step, and whereby the first numerical aperture is smaller than the second numerical aperture.

2. The apparatus of claim 1, whereby an objective having a variable numerical aperture is used for performing the optical detection step and for performing the optical spectroscopic step.

3. The apparatus of claim 1, whereby the optical detection step is performed by means of an imaging method.

4. The apparatus of claims 1, whereby Raman spectroscopy is used for performing the optical spectroscopic step.

5. The apparatus of claim 1, whereby fluorescence spectroscopy is used for performing the optical spectroscopic step.

6. The apparatus of claim 1, whereby elastic scattering spectroscopy is used for performing the optical spectroscopic step.

7. The apparatus of claim 1, whereby infrared spectroscopy is used for performing the optical spectroscopic step.

8. The apparatus of claim 1, whereby photo-acoustic spectroscopy is used for performing the optical spectroscopic step.

9. The apparatus of claim 1, whereby the first numerical aperture is below 0.3, in particular below 0.2, preferably 0.1.

10. The apparatus of claim 1, whereby the second numerical aperture is above 0.6, in particular above 0.7, preferably between 0.7 and 0.9.

11. The apparatus of claim 1, further comprising tracking a movement of the biological tubular structure by imaging of the biological tubular structure with the second numerical aperture.

12. The apparatus of claim 1, further comprising optically determining a depth of the biological tubular structure under a surface of the body using the second numerical aperture.

13. The apparatus of claim 12, further comprising performing a number of imaging steps with the second numerical aperture for scanning along a direction being transversal to the surface of the body in order to determine the depth.

14. The apparatus of claim 1, whereby the fluid is blood and the biological tubular structure is a blood vessel.

15. The apparatus of claim 1, whereby the first numerical aperture is used for determining two dimensions of the position and the second numerical aperture is used for determining the third dimension of the position.

16. A computer program product, in particular a digital storage medium, for controlling of optical detection means and optical spectroscopic means by the steps of:
controlling of the optical detection means for determining a position of a biological tubular structure through which a fluid flows,
controlling of the optical spectroscopic means to determine a property of the fluid in a detection volume, a location of the detection volume being determined by the position,
whereby the optical detection means is controlled to perform the position determination with a first numerical aperture and the optical spectroscopic means is controlled to perform the spectroscopic determination of the property using a second numerical aperture, whereby the first numerical aperture is smaller than the second numerical aperture.

17. An apparatus for determining a property of a fluid which flows through a biological tubular structure, the apparatus comprising:
optical detection means for determining a position of the biological tubular structure,
optical spectroscopic means for determining a property of the fluid in a detection volume, the location of the detection volume being determined by the optical detection system,
optical means for providing a first numerical aperture for the determination of the position by means of the optical detection means and for providing a second numerical aperture for the spectroscopic determination of the property by means of the optical spectroscopic means, the first numerical aperture being smaller than the second numerical aperture.

18. A method of determining a property of a fluid which flows through a biological tubular structure, the method comprising:
performing an optical detection step for determining a position of the biological tubular structure,
performing an optical spectroscopic step for determining of the property of the fluid in a detection volume, the location of the detection volume being determined by the position,
whereby a first numerical aperture is used for performing the optical detection step and a second numerical aperture is used for performing the optical spectroscopic step, and whereby the first numerical aperture is smaller than the second numerical aperture.
